(19) United States
(12) Patent Application Publication
(10) Pub. No.: US 2011/0017720 A1
(43) Pub. Date: Jan. 27, 2011

(54) Warming appratus for fuel gas cylinder

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/458,713

(22) Filed: Jul. 21, 2009

(51) Int. Cl. H05B 3/02; H05B 1/02

(52) U.S. Cl. 219/438; 219/510

(57) ABSTRACT

Disclosed is a vaporization enhancer for fuel gas cylinder comprising a warmer capable of warming the fuel gas cylinder, a temperature control switch that is automatically turned on when the temperature is too low, a flow-sensitive switch that is turned on when the fuel gas flows out through the gas outlet pipe of the fuel gas cylinder, and a fuel gas residual amount sensing unit that is turned on when the amount of fuel gas stored in the fuel gas cylinder is too small. Only when the fuel gas residual amount sensing unit, the temperature control switch, and the flow-sensitive switch are simultaneously turned on, the warmer warms the fuel gas cylinder thereby enhancing the safety in use.

### BACKGROUND OF THE INVENTION

(a) Field of the Invention

The present invention relates to equipment associated with a fuel gas cylinder, and more particularly to a vaporization enhancer for a fuel gas cylinder capable of warming a residual amount of liquid fuel gas within the fuel gas cylinder for use in burners.

(b) Description of the Prior Art

Gas drums are common fuel facilities in modern homes. The drum gas is combustible fuel gas stored in a fuel gas cylinder. The fuel gas is often stored within the fuel gas cylinder in a liquid form at high pressure to increase the amount of fuel gas in the fuel gas cylinder. When it is desired to use the fuel gas, the pressure of liquid fuel gas within the fuel gas cylinder is reduced is and released through the gas outlet pipe of the fuel gas cylinder such that the liquid fuel gas is converted into a gaseous form for combustion use in burners.

However, in higher latitude areas or when the weather is cold, liquid fuel gas cannot be vaporized due to excessively low temperature thereby causing trouble in use. Particularly after the liquid fuel gas has been used in a low-temperature environment for a period of time, the fuel gas cylinder exchanges heat with the external low temperature for a long time so that the liquid fuel gas within the fuel gas cylinder cannot absorb sufficient vaporization heat and the fuel gas supply is interrupted. This causes much trouble for a user.

Furthermore, even if the external temperature is not lowered, when the fuel gas is used and reduced to a certain residual amount, the difference in pressure between the fuel gas cylinder and the external environment is decreased such that the residual fuel gas within the fuel gas cylinder is not easy to be released for use and still remains in the fuel gas cylinder, resulting in a waste of fuel gas.

Therefore, in order to avoid the above-mentioned waste of fuel gas, some users would roll the fuel gas cylinder on the ground whereby the fuel gas is guided from the bottom of the fuel gas cylinder to the upper position of the s fuel gas cylinder so as to release the residual fuel gas for combustion use in burners. Additionally, some users would dip the bottom of the fuel gas cylinder into hot water. Heat is transferred from the hot water to the fuel gas cylinder by heat exchange to increase the entropy of fuel gas molecules within the fuel gas cylinder such that the fuel gas molecules move rapidly and are released from the fuel gas cylinder for combustion use in burners.

All the above-mentioned methods can achieve the purpose of releasing residual fuel gas from a fuel gas cylinder. Nevertheless, a fuel gas cylinder is often made of steel, which is very heavy and not easy to be moved. Besides, not only is it difficult to roll such a heavy fuel gas cylinder from both sides or dip it into hot water, but also improper operation may wet the user's body or hurt the user's toes. So, they are quite time-consuming and inconvenient.

Therefore, there has been disclosed in the prior art a warmer capable of warming a fuel gas cylinder. The warmer is comprised of a warming sheet disposed below the fuel gas cylinder and a control circuit. The control circuit comprises a timer switch and a bimetallic temperature control switch for detecting the temperature of the external environment and the temperature of the fuel gas cylinder. When the temperature of the external environment is too low, the control circuit controls the warming sheet to automatically warm the fuel gas cylinder. It has the convenience of use.

Although the aforementioned prior art warmer can automatically warm a fuel gas cylinder when the environmental temperature is too low and provides a certain level of convenience in use, in fact, much potential risk exists. For example, a fuel gas cylinder just filled with fuel gas is located in a low-temperature environment, but it does not require warming. If the aforementioned warmer is used to automatically warm the fuel gas cylinder filled with fuel gas, it is very easy to cause the danger of the fuel gas cylinder explosion due to the overpressure inside the cylinder.

In view of the above-mentioned circumstances, the inventors have done many years of research and experiments in the related fields, to develop a vaporization enhancer for fuel gas cylinder with a design feature that allows automatic warming of a fuel gas cylinder only when the external temperature is too low and when the residual amount of fuel gas within the fuel gas cylinder is too small. Thus, the risk of warming a fuel gas cylinder is reduced and the purpose of improving the safety in use can be achieved.

### SUMMARY OF THE INVENTION

It is an object of the present invention to provide a vaporization enhancer for fuel gas cylinder capable of automatically vaporizing liquid fuel gas that is difficult to be vaporized within the fuel gas cylinder for use in burners to achieve the purposes of energy saving and safety in use.

To achieve the foregoing object, the vaporization enhancer for fuel gas cylinder according to the present invention comprises a warmer capable of warming the fuel gas cylinder, a fuel gas residual amount sensing unit electrically connected to the warmer, a temperature control switch and a flow-sensitive switch. Only when the fuel gas residual amount sensing unit, the temperature control switch, and the flow-sensitive switch are simultaneously turned on, the warmer warms the fuel gas cylinder to vaporize the residual amount of liquid fuel gas within the fuel gas cylinder for use in burners.

The fuel gas residual amount sensing unit used in the practice of the present invention may be a weight detector disposed at the bottom of the fuel gas cylinder. The weight of the fuel gas cylinder in turn decreases with the usage of fuel gas so that the fuel gas storage amount can be determined according to the weight of the fuel gas cylinder detected by the weight detector, then performing an on-off operation.

Furthermore, the fuel gas residual amount sensing unit used in the practice of the present invention may be a pressure detector installed on the gas outlet pipe of the fuel gas cylinder. The pressure detector can determine how much the fuel gas is stored according to different pressures generated by different amounts of fuel gas stored in the fuel gas cylinder. If the detected fuel gas storage amount is too small, the fuel gas residual amount sensing unit is turned on. If the detected fuel gas storage amount exceeds a set volume, the fuel gas residual amount sensing unit is turned off.

The aforementioned temperature control switch can perform related on-off operations according to the detected external temperature value. When the external temperature detected by the temperature control switch is lower than a set temperature, the temperature control switch is turned on. When the external temperature detected by the temperature control switch is higher than a set temperature, the temperature control switch is turned off.

The aforementioned flow-sensitive switch is installed at the position near the pressure reducing valve on the gas outlet pipe of the fuel gas cylinder. It can perform related on-off operations according to whether or not the fuel gas cylinder supplies fuel gas to burners. When the flow-sensitive switch detects that the fuel gas flows out through the gas outlet pipe of the fuel gas cylinder, it is turned on. When the flow-sensitive switch detects that no fuel gas flows out through the gas outlet pipe of the fuel gas cylinder, the flow-sensitive switch is turned off.

The aforementioned warmer is disposed at the bottom of the fuel gas cylinder to warm the liquid fuel gas within the fuel gas cylinder for combustion use in burners. Besides, only when the aforementioned fuel gas residual amount sensing unit, temperature control switch, and flow-sensitive switch are simultaneously turned on, the warmer warms the fuel gas cylinder. For example, if the external temperature is lower than a set value but the user does not open the fuel gas cylinder valve to supply fuel gas to the burners, the temperature control switch is turned on. However, the flow-sensitive switch is not turned on. As a result, the warmer would not warm the fuel gas cylinder, capable of saving energy and enhancing the safety in use.

Furthermore, if the external temperature is lower than a set value but the cylinder is fully loaded with fuel gas, the temperature control switch is turned on but the fuel gas residual amount sensing unit is not turned on. Accordingly, the warmer would not warm the fuel gas cylinder. This can avoid warming the fuel gas cylinder when fully loaded with fuel gas and the danger of excessive pressure build-up in the fuel gas cylinder so as to achieve the purpose of safety in use. Therefore, the present invention not only has the function of warming a fuel gas cylinder, but also has safe use effect.

Additionally, in order to disclose the various implementation modes is and design details of the present invention in more detail, the various implementation modes of the present invention will be further described and explained as below:

The aforementioned warmer used in the practice of the present invention may be a thermostatic electric heater, or may be a heater particularly designed to match the shape of the fuel gas cylinder. Moreover, for the convenience of manufacture and use, the warmer may be disposed along with the aforementioned weight detector: In the practice of the present invention, the weight detector may be approximately formed as a centrally recessed ring for receiving the bottom of the fuel gas cylinder and measuring the weight of the fuel gas cylinder. The warmer may be disposed in the central recess of the annular weight detector and has an approximately disk shape in contact with a large area of the bottom of the fuel gas cylinder, thus achieving better warming effect. In order to ensure that the warmer is indeed in contact with the bottom of the fuel gas cylinder, the warmer may be further provided at its bottom with a resilient element, whereby the resilient element is propped resiliently upward against the warmer to ensure the contact between the warmer and the fuel gas cylinder, then warming the fuel gas cylinder.

Further, in the practice of the present invention, the liquid fuel gas cannot flow out through the gas outlet pipe of the fuel gas cylinder due to excessively low temperature, so the aforementioned flow-sensitive switch cannot exhibit its sensing function or the aforementioned fuel gas residual amount sensing unit and temperature control switch fail and have no sensing function. Hence, in order to avoid the above problem, a manual warming portion may be further provided, which directly controls the activation of the warmer to warm the fuel gas cylinder.

In addition, for more clearly understanding the current operating condition and for convenient operation of the warming apparatus in use, the warming apparatus used in the practice of the present invention can further comprise an operating unit provided for the disposition of the aforementioned manual warming portion and temperature control switch. The operating unit used in the practice of the present invention further comprises a first, second, third, and fourth signal light. The aforementioned four kinds of signal lights can be displayed as four different colors, such as blue, green, yellow, and red, for discrimination. When the manual warming portion is activated, the first signal light can be turned out for recognition of the state of the manual warming portion which is currently activated. When the warmer is activated, the second signal light can be turned out for recognition of the state of the warmer which is currently activated. The second signal light can correspondingly indicate the on/off state of the warmer. Besides, when the vaporization enhancer for fuel gas cylinder is energized and in an armed state, the second signal light can blink at a specific frequency for the user to recognize the state of the vaporization enhancer for fuel gas cylinder, which is currently energized and in an armed state. The third and fourth signal lights can be used to indicate the residual amount of fuel gas.

The third and fourth signal lights indicate the residual amount of fuel gas in such a manner that the residual amount of fuel gas detected by the fuel gas residual amount sensing unit is divided by two set values into a low residual state and a state necessary for replacement. When the amount of fuel gas within the fuel gas cylinder detected by the fuel gas residual amount sensing unit is reduced to a low residual value, the third signal light can be turned on and lighted to recognize that the fuel gas is in a low residual state. When the amount of fuel gas within the fuel gas cylinder detected by the fuel gas residual amount sensing unit is reduced to a residual value given by the replacement conditions, the fourth signal light is lighted to recognize that the fuel gas is in a state necessary for replacement.

Furthermore, the operating unit used in the practice of the present invention may be provided with a buzzer for recognition of various operating conditions by sound. For example, when the amount of fuel gas within the fuel gas cylinder detected by the fuel gas residual amount sensing unit is reduced to a low residual value, the buzzer emits a gentle buzz for warning. When the amount of fuel gas within the fuel gas cylinder detected by the fuel gas residual amount sensing unit is reduced to a residual value given by the replacement conditions, the buzzer gives a short buzz for warning. The buzzer can achieve the purpose of discrimination between various operating conditions via buzzes of various different frequencies.

In addition, the vaporization enhancer for fuel gas cylinder may be provided with a manual turn-off portion in coordination with the signal lights and the buzzer of the operating unit such that the user can turn off the signal lights and the buzzer manually after recognizing various operating conditions to prevent the operating unit from affecting the user's operation. The operating unit may be further provided with a display module electrically connected to the fuel gas residual amount sensing unit. The display module displays the current storage state of the fuel gas to achieve the purpose of ease of use.

Compared with the prior art, the vaporization enhancer for fuel gas cylinder according to the present invention not only can vaporize liquid fuel gas that is difficult to be vaporized for use, but also has the effects of saving operation time and improving the safety.

### BRIEF DESCRIPTION OF THE DRAWINGS

FIG. 1 is a three-dimensional appearance diagram of a warming apparatus according to the present invention, which is installed on a fuel gas cylinder and a burner.

FIG. 2 is a schematic view showing a three-dimensional appearance of the present invention.

FIG. 3 is a three-dimensional view of a part of the warming apparatus illustrating a relative position between a temperature control switch, a manual warming portion, an operating unit, a manual turn-off portion and a display module.

FIG. 4 is a schematic view showing a three-dimensional appearance of a warmer disposed together with a weight detector according to the present invention.

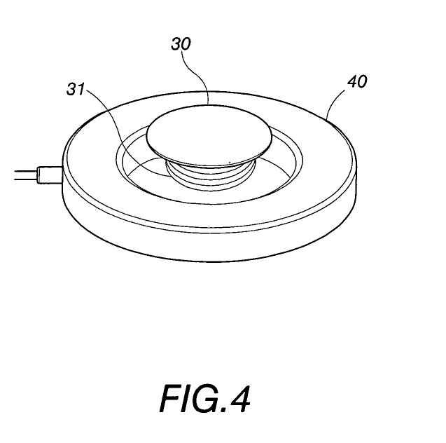

FIG. 5 is a schematic view showing a circuit relationship of the present invention.

### DETAILED DESCRIPTION OF THE PREFERRED EMBODIMENTS

According to the technical means of the present invention, the implementation modes suitable for the present invention will be hereinafter described with reference to the drawings.

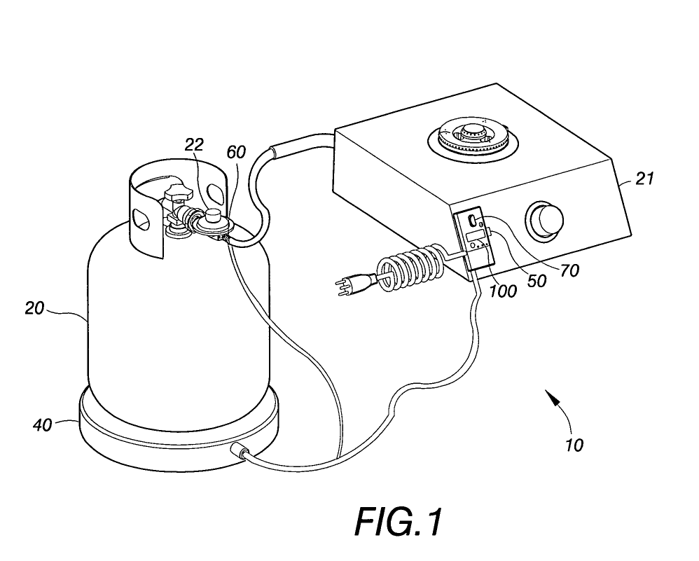

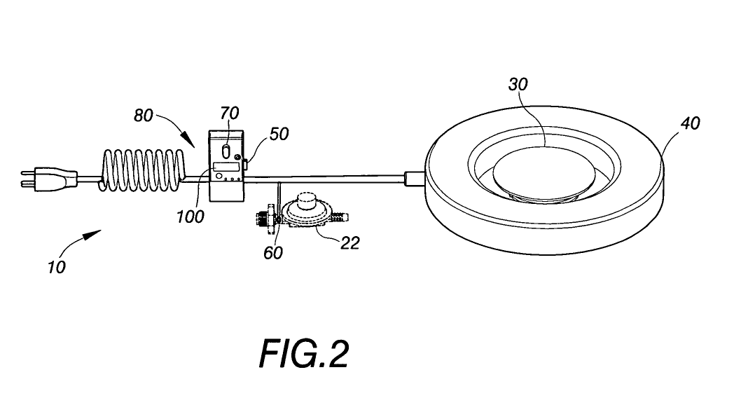

As illustrated in FIGS. 1 and 2, the vaporization enhancer 10 for fuel gas cylinder according to the present invention comprises a warmer 30 capable of warming the fuel gas cylinder 20, a fuel gas residual amount sensing unit 40 electrically connected to the warmer 30, a temperature control switch 50 and a flow-sensitive switch 60. Only when the fuel gas residual amount sensing unit 40, the temperature control switch 50, and the flow-sensitive switch 60 are simultaneously turned on, the warmer 30 warms the fuel gas cylinder 20 to vaporize the residual amount of liquid fuel gas within the fuel gas cylinder 20 for use in a burner 21.

The fuel gas residual amount sensing unit 40 used in the practice of the present invention may be a weight detector disposed at the bottom of the fuel gas cylinder 20. The weight of the fuel gas cylinder 20 in turn decreases with the usage of fuel gas so that the fuel gas storage amount can be determined according to the weight of the fuel gas cylinder 20 detected by the weight detector, then performing an on-off operation.

Furthermore, the fuel gas residual amount sensing unit 40 used in the practice of the present invention may be a pressure detector (not shown) installed on the gas outlet pipe 22 of the fuel gas cylinder 20. The pressure detector can determine how much the fuel gas is stored according to different pressures generated by different amounts of fuel gas stored in the fuel gas cylinder 20. If the detected fuel gas storage amount is too small, the fuel gas residual amount sensing unit 40 is turned on. If the detected fuel gas storage amount exceeds a set volume, the fuel gas residual amount sensing unit 40 is turned off.

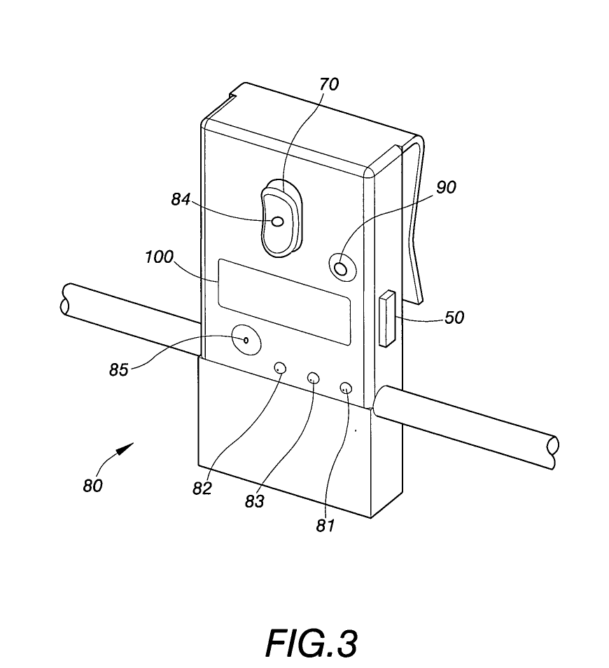

As illustrated in FIG. 3, the aforementioned temperature control switch 50 can perform related on-off operations according to the detected external temperature value. When the external temperature detected by the temperature control switch 50 is lower than a set temperature, the temperature control switch 50 is turned on. When the external temperature detected by the temperature control switch 50 is higher than a set temperature, the temperature control switch 50 is turned off.

As illustrated in FIGS. 1 and 2, the aforementioned flow-sensitive switch 60 is installed at the position near the pressure reducing valve on the gas outlet pipe 22 of the fuel gas cylinder 20. It can perform related on-off operations according to whether or not the fuel gas cylinder 20 supplies fuel gas to the burner 21. When the flow -sensitive switch 60 detects that the fuel gas flows out through the gas outlet pipe 22 of the fuel gas cylinder 20, it is turned on. When the flow-sensitive switch 60 detects that no fuel gas flows out through the gas outlet pipe 22 of the fuel gas cylinder 20, the flow-sensitive switch 60 is turned off.

As illustrated in FIGS. 1 to 3, the aforementioned warmer 30 is disposed at the bottom of the fuel gas cylinder 20 to warm the liquid fuel gas within the fuel gas cylinder 20 for combustion use in the burner 21. Besides, only when the aforementioned fuel gas residual amount sensing unit 40, temperature control switch 50, and flow-sensitive switch 60 are simultaneously turned on, the warmer 30 warms the fuel gas cylinder 20. For example, if the external temperature is lower than a set value but the user does not open the valve of the fuel gas cylinder 20 to supply fuel gas to the burner 21, the is temperature control switch 50 is turned on. However, the flow-sensitive switch 60 is not turned on. As a result, the warmer 30 would not warm the fuel gas cylinder 20, capable of saving energy and enhancing the safety in use.

Furthermore, if the external temperature is lower than a set value but the cylinder is fully loaded with fuel gas, the temperature control switch 50 is turned on but the fuel gas residual amount sensing unit 40 is not turned on. Accordingly, the warmer 30 would not warm the fuel gas cylinder 20. This can avoid warming the fuel gas cylinder 20 when fully loaded with fuel gas and the danger of excessive pressure build-up in the fuel gas cylinder 20 so as to achieve the purpose of safety in use. Therefore, the present invention not only has the function of warming a fuel gas cylinder 20, but also has safe use effect.

Additionally, in order to disclose the various implementation modes and design details of the present invention in more detail, the various implementation modes of the present invention will be further described and explained as below:

As illustrated in FIGS. land 4, the aforementioned warmer 30 used in the practice of the present invention may be a thermostatic electric heater, or may be a heater particularly designed to match the shape of the fuel gas cylinder 20. Moreover, for the convenience of manufacture and use, the warmer 30 may be disposed along with the aforementioned weight detector. In the practice of the present invention, the weight detector may be approximately formed as a centrally recessed ring for receiving the bottom of the fuel gas cylinder 20 and measuring the weight of the fuel gas cylinder 20. The warmer 30 may be disposed in the central recess of the annular weight detector and has an approximately disk shape in contact with a large area of the bottom of the fuel gas cylinder 20, thus achieving better warming effect. In order to ensure that the warmer 30 is indeed in contact with the bottom of the fuel gas cylinder 20, the warmer 30 may be further provided at its bottom with a resilient element 31, whereby the resilient element 31 is propped resiliently upward against the warmer 30 to ensure the contact between the warmer 30 and the fuel gas cylinder 20, then warming the fuel gas cylinder 20.

Furthermore, as illustrated in FIGS. 1 to 3, in the practice of the present invention, the liquid fuel gas cannot flow out through the gas outlet pipe 22 of the fuel gas cylinder 20 due to excessively low temperature, so the aforementioned flow-sensitive switch 60 cannot exhibit its sensing function or the aforementioned fuel gas residual amount sensing unit 40 and temperature control switch 50 fail and have no sensing function. Hence, in order to avoid the above problem, a manual warming portion 70 may be further provided, which directly controls the activation of the warmer 30 to warm the fuel gas cylinder 20.

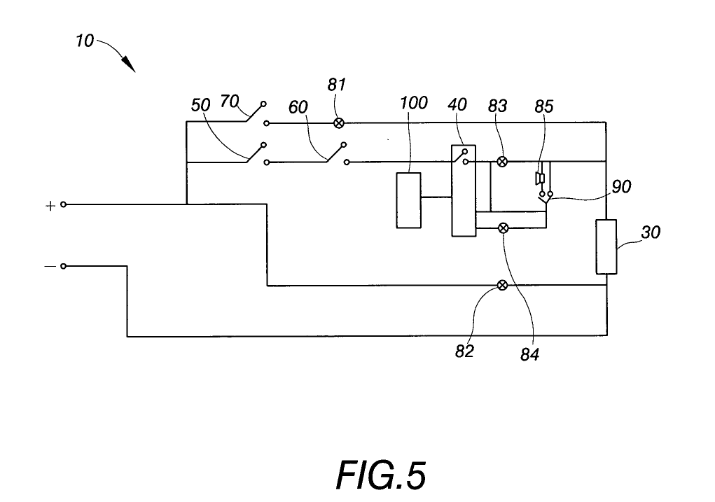

In addition, as illustrated in FIGS. 1, 3 and 5, for more clearly understanding the current operating condition and for convenient operation of the warming apparatus in use, the warming apparatus used in the practice of the present invention can further comprise an operating unit 80 provided for the disposition of the aforementioned manual warming portion 70 and temperature control switch 50. The operating unit 80 used in the practice of the present invention further comprises a first, second, third, and fourth signal light 81, 82, 83, 84. The aforementioned four kinds of signal lights can be displayed as four different colors, such as blue, green, yellow, and red, for discrimination.

When the manual warming portion 70 is activated, the first signal light 81 can be turned out for recognition of the state of the manual warming portion 70 which is currently activated. When the warmer 30 is activated, the second signal light 82 can be turned out for recognition of the state of the warmer 30 which is currently activated. The second signal light 82 can correspondingly indicate the on/off state of the warmer 30. Besides, when the vaporization enhancer 10 for fuel gas cylinder is energized and in an armed state, the second signal light 82 can blink at a specific frequency for the user to recognize the state of the vaporization enhancer 10 for fuel gas cylinder, which is currently energized and in an armed state. The third and fourth signal lights 83, 84 can be used to indicate the residual amount of fuel gas.

The third and fourth signal lights 83, 84 indicate the residual amount of fuel gas in such a manner that the residual amount of fuel gas detected by the fuel gas residual amount sensing unit 40 is divided by two set values into a low residual state and a state necessary for replacement. When the amount of fuel gas within the fuel gas cylinder 20 detected by the fuel gas residual amount sensing unit 40 is reduced to a low residual value, the third signal light 83 can be turned on and lighted to recognize that the fuel gas is in a low residual state. When the amount of fuel gas within the fuel gas cylinder 20 detected by the fuel gas residual amount sensing unit 40 is reduced to a residual value given by the replacement conditions, the fourth signal light 84 is lighted to recognize that the fuel gas is in a state necessary for replacement.

Furthermore, the operating unit 80 used in the practice of the present invention may be provided with a buzzer 85 for recognition of various operating conditions by sound. For example, when the amount of fuel gas within the fuel gas cylinder 20 detected by the fuel gas residual amount sensing unit 40 is reduced to a low residual value, the buzzer 85 emits a gentle buzz for warning. When the amount of fuel gas within the fuel gas cylinder 20 detected by the fuel gas residual amount sensing unit 40 is reduced to a residual value given by the replacement conditions, the buzzer 85 gives a short buzz for warning. The buzzer 85 can achieve the purpose of discrimination between various operating conditions via buzzes of various different frequencies.

In addition, the vaporization enhancer 10 for fuel gas cylinder may be provided with a manual turn-off portion 90 in coordination with the signal lights and the buzzer 85 of the operating unit 80 such that the user can turn off the signal lights and the buzzer 85 manually after recognizing various operating conditions to prevent the operating unit 80 from affecting the user's operation. The operating unit 80 may be further provided with a display module 100 electrically connected to the fuel gas residual amount sensing unit 40. The display module 100 displays the current storage state of the fuel gas to achieve the purpose of ease of use.

The names of the members composing the present invention are only for illustrating preferred embodiments of the present invention, and not for giving any limitation to the scope of the present invention. The ordinary technical persons who have skills in the present field can make different types of corresponding amendments according to the basic inventive ideas of this application. However, the related changes or alternations would still fall within the protection scope of the application.

1. A vaporization enhancer for fuel gas cylinder comprising:
a temperature control switch capable of detecting an external temperature, which is automatically turned on when the external temperature is lower than a set value;
a flow-sensitive switch installed on the gas outlet pipe of the fuel gas cylinder, which is automatically turned on when the fuel gas flows out through the gas outlet pipe of the fuel gas cylinder;
a fuel gas residual amount sensing unit capable of detecting the amount of fuel gas stored in the fuel gas cylinder, which is automatically turned on when the amount stored in the fuel gas cylinder is too small; and a warmer capable of warming the fuel gas cylinder, wherein only when said temperature control switch, said flow-sensitive switch and said fuel gas residual amount sensing unit are simultaneously turned on, the warmer is activated to warm the fuel gas cylinder.

2. The warming-apparatus vaporization enhancer for fuel gas cylinder as claimed in claim 1, wherein the fuel gas residual amount sensing unit is a pressure detector installed on the gas outlet pipe of the fuel gas cylinder to detect the amount of fuel gas stored in the fuel gas cylinder by pressure difference.

3. The vaporization enhancer for fuel gas cylinder as claimed in claim 1, wherein the fuel gas residual amount sensing unit is a weight detector disposed at the bottom of the fuel gas cylinder to detect the amount of fuel gas stored in the fuel gas cylinder by weight difference.

4. The vaporization enhancer for fuel gas cylinder as claimed in claim 1, wherein the warmer is disposed at the bottom of the fuel gas cylinder and has a disk shape in contact with a large area of the bottom of the fuel gas cylinder.

5. The vaporization enhancer for fuel gas cylinder as claimed in claim 1, further comprising a manual warming portion capable of directly controlling the activation of the warmer to warm the fuel gas cylinder.

6. The vaporization enhancer for fuel gas cylinder as claimed in claim 5, wherein the manual warming portion is disposed on an operating unit.

7. The warming-apparatus vaporization enhancer for fuel gas cylinder as claimed in claim 6, wherein the operating unit is further provided thereon with a first signal light that is turned on for recognition when the manual warming portion is activated.

8. The vaporization enhancer for fuel gas cylinder as claimed in claim 6, wherein the operating unit is further provided thereon with a second signal light that is turned on for recognition when the warmer is activated, and the second signal light blinks at a specific frequency for recognition when the vaporization enhancer for fuel gas cylinder is energized and in an armed state.

9. The vaporization enhancer for fuel gas cylinder as claimed in claim 6, wherein the operating unit is further provided thereon with a third signal light and a fourth signal light, and wherein the third signal light is correspondingly turned on when the residual amount of fuel gas detected by the fuel gas residual amount sensing unit is reduced to a low residual value, and the fourth signal light is turned on and lighted for recognition when the residual amount of fuel gas detected by the fuel gas residual amount sensing unit is reduced to a residual value given by the replacement conditions.

10. The vaporization enhancer for fuel gas cylinder as claimed in claim 6, wherein the operating unit is further provided thereon with a buzzer for recognition of the operation state by sound.

11. The vaporization enhancer for fuel gas cylinder as claimed in claim 6, wherein the operating unit is further provided thereon with a display module electrically connected to the fuel gas residual amount sensing unit to display the current storage state of the fuel gas.
